(19) United States
(12) Patent Application Publication
(10) Pub. No.: US 2022/0112373 A1
(43) Pub. Date: Apr. 14, 2022

(54) THERMOSETTING RESIN COMPOSITION

(71) Applicant: SHOWA DENKO K.K., Tokyo (JP)

(72) Inventor: Chika MINEZAKI, Tokyo (JP)

(73) Assignee: SHOWA DENKO K.K., Tokyo (JP)

(21) Appl. No.: 17/421,903

(22) PCT Filed: Sep. 18, 2019
(86) PCT No.: PCT/JP2019/036610

§ 371 Date: Jul. 9, 2021

(30) Foreign Application Priority Data
Jan. 24, 2019 (JP) 2019-010424

(51) Int. Cl. C08L 79/08

(52) U.S. Cl. CPC C08L 79/08; C08L 2205/03

(57) ABSTRACT

Provided is a thermosetting resin composition which exhibits low water absorption and excellent reflow resistance properties without compromising heat resistance or moldability. This thermosetting resin composition contains a polyalkenylphenol compound (A), a polymaleimide compound (B), a liquid polybutadiene compound (C) and a radical initiator (D). The liquid polybutadiene compound (C) has structural units represented by formula (1)-1 and, optionally, structural units represented by formula (l)-2 and, optionally, structural units other than the structural units represented by formula (1)-1 and formula (1)-2. If the average number of structural units represented by formula (1)-1 per molecule is denoted by m, the average number of structural units represented by formula (1)-2 per molecule is denoted by n and the average number of structural units other than the structural units represented by formula (1)-1 and formula (1)-2 is denoted by w, the value of m/(m+n+w) is 0.15-1.

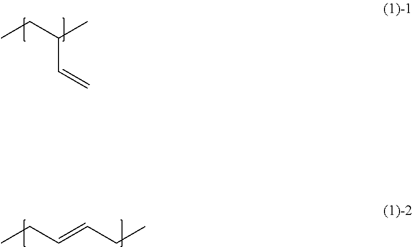

### FIELD

The present invention relates to a thermosetting resin composition, a cured product thereof, a method of manufacturing a structure using the thermosetting resin composition, and a structure including the cured product.

### BACKGROUND

Recently, a semiconductor package used in electronic equipment and industrial equipment has been required to have properties, such as high density wiring, miniaturization, thinning, high heat resistance, and high heat dissipation, with the high density integration of electronic components. Therefore, a sealing material which is a plastic material is also required to have high heat resistance.

Transfer molding is a method in which a material is heat softened in a plunger, and the heat softened material is pushed into a heated mold cavity through a channel in the mold, such as a gate, sprue, or runner, and cured in the mold cavity. This enables molding at low pressures, since the material is injected into the cavity in a highly flowable state. Transfer molding is characterized by less damage to the insert as compared with other molding methods that require high pressure. Transfer molding is known as a typical molding method in the sealing molding of power semiconductors and ICs, since it allows for miniaturization and micromachining and has high productivity.

Conventionally, an epoxy-phenolic thermosetting resin material has been utilized as a sealing material used in transfer molding. However, it is difficult to cope with recent requirements for high heat resistance by conventional materials. In order to meet the requirements for high heat resistance, there has been proposed a sealing material in which a resin system is variously devised, for example, a thermosetting resin composition in which a large amount of a polyfunctional epoxy resin is blended, a thermosetting resin composition containing a high heat-resistant structure, such as a bismaleimide, a triazine skeleton, a benzoxazine skeleton, and a silsesquioxane skeleton.

Patent Literature 1 (JPH11-140277A) describes (A) a phenolic resin containing 30 to 100 parts by mass of a phenolic resin having a novolak structure containing a biphenyl derivative and/or a naphthalene derivative in a molecule in a total phenolic resin amount, (B) an epoxy resin containing 30 to 100 parts by mass of an epoxy resin having a novolak structure containing a biphenyl derivative and/or a naphthalene derivative in a molecule in a total epoxy resin amount, (C) an inorganic filler, and (D) a curing accelerator as an essential component.

Patent Literature 2 (JPH05-43630A) describes an aromatic bismaleimide resin composition containing N,N′-(alkyl-substituted diphenylmethane)bismaleimide and a polyallylphenol derived from a condensed polyphenol of salicylaldehyde and phenol.

Patent Literature 3 (JPH05-6869A) describes a semiconductor device in which a semiconductor element is sealed using a resin composition containing (A) a maleimide compound having 2 or more maleimide groups in a molecule, (B) an allylated phenol resin having a specific repeating unit, and (C) a curing catalyst.

Patent Literature 4 (JPH16-93047A) describes a curable resin composition comprising a maleimide compound, an alkenylphenol compound having a specific structure, and an organosilane compound having an epoxy group, in a specific ratio.

### CITATION LIST

### Patent Literature

[PTL 1] JPH11-140277A

[PTL 2] JPH05-43630A

[PTL 3] JPH05-6869A

[PTL 4] JPH06-93047A

### SUMMARY

### Technical Problem

When a resin system used for a sealing material is largely changed, there may be a problem in balancing a plurality of properties having trade-offs with one another. For example, when high heat resistance of a sealing material is sought, there may be mentioned an increase in the number of functional groups of an epoxy resin to increase a crosslinking density (Patent Literature 1), or blending a maleimide resin as an additional resin (Patent Literatures 2 to 4). However, according to these techniques, the water absorption rate of the sealing material increases, or the elastic modulus of a cured product of the sealing material tends to increase due to the high crosslinking density. Therefore, when actually manufacturing a semiconductor package using these sealing materials, moisture absorbed in the sealing material under solder reflow conditions at the time of semiconductor mounting is evaporated, the sealing material and internal parts are separated, or the sealing material may crack. It is very difficult to obtain a sealing material having both heat resistance and reflow resistance, and practical moldability at the same time. Thus, such a sealing material is strongly desired.

In the present disclosure, a thermosetting resin composition having low water absorption and excellent reflow resistance without impairing heat resistance and moldability is described.

### Solution to Problem

A thermosetting resin composition comprising a polyalkenylphenol compound (A), a polymaleimide compound (B), a liquid polybutadiene compound (C), and a radical initiator (D), wherein the liquid polybutadiene compound (C) has a structural unit represented by the formula (1)-1:

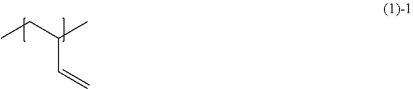

and optionally a structural unit represented by the formula (1)-2:

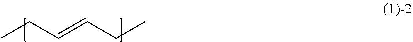

and optionally a structural unit other than the structural units represented by the formula (1)-1 and the formula (1)-2, wherein the ratio of m/(m+n+w) is 0.15 to 1, when the average number per one molecule of the structural unit represented by the formula (1)-1 is defined as m, the average number per one molecule of the structural unit represented by the formula (1)-2 is defined as n, and the average number per one molecule of the structural unit other than the structural units represented by the formula (1)-1 and the formula (1)-2 is defined as w.

[2] The thermosetting resin composition according to [1], wherein the content of the liquid polybutadiene compound (C) is 5 to 40% by mass based on the total of the polyalkenylphenol compound (A), the polymaleimide compound (B), and the liquid polybutadiene compound (C).

[3] The thermosetting resin composition according to [1] or [2], wherein the number average molecular weight Mn of the liquid polybutadiene compound (C) is 2000 to 50000.

[4] The thermosetting resin composition according to any one of [1] to [3], wherein the liquid polybutadiene compound (C) contains at least one selected from polybutadiene, a butadiene-styrene copolymer, and maleic acid-modified polybutadiene.

[5] The thermosetting resin composition according to any one of [1] to [4], wherein the polyalkenylphenol compound (A) is a polyalkenylphenol compound having a structural unit represented by the formula (2)-1:

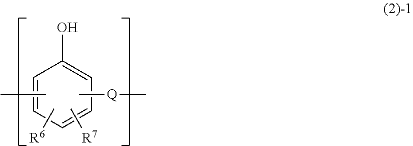

and optionally a structural unit represented by the formula (2)-2:

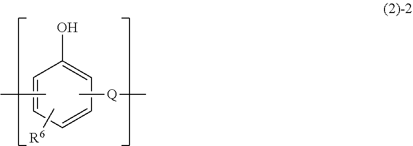

wherein, in the formula (2)-1 and the formula (2)-2, R⁶ is each independently a hydrogen atom, an alkyl group having 1 to 5 carbon atoms, or an alkoxy group having 1 to 5 carbon atoms, and R⁷ is each independently an alkenyl group represented by the formula (3):

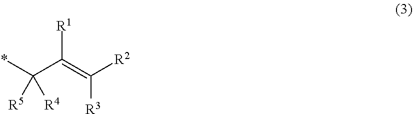

wherein, in the formula (3), R¹, R², R³, R⁴ and R⁵ are each independently a hydrogen atom, an alkyl group having 1 to 5 carbon atoms, a cycloalkyl group having 5 to 10 carbon atoms, or an aryl group having 6 to 12 carbon atoms, and * of the formula (3) is a bond portion with a carbon atom constituting an aromatic ring, and R⁶ and R⁷ may be the same or different in each of the phenol skeletal units, and Q is independently an alkylene group represented by the formula —CR⁸R⁹—, a cycloalkylene group having 5 to 10 carbon atoms, a divalent organic group having an aromatic ring, a divalent organic group having an alicyclic fused ring, or a divalent organic group formed by combining these, and R⁸ and R⁹ are each independently a hydrogen atom, an alkyl group having 1 to 5 carbon atoms, an alkenyl group having 2 to 6 carbon atoms, a cycloalkyl group having 5 to 10 carbon atoms, or an aryl group having 6 to 12 carbon atoms.

[6] The thermosetting resin composition according to [5], wherein p is a real number of 1.1 to 35, p+q is a real number of 1.1 to 35, and q is a real number in which the value of the formula: p/(p+q) is 0.4 to 1, where p is the average number per one molecule of the structural unit represented by the formula (2)-1 and q is the average number per one molecule of the structural unit represented by the formula (2)-2.

[7] The thermosetting resin composition according to any one of [1] to [6], wherein the polymaleimide compound (B) is an aromatic bismaleimide compound.

[8] The thermosetting resin composition according to any one of [1] to [7], wherein the radical initiator (D) is an organic peroxide.

[9] The thermosetting resin composition according to any one of [1] to [8], further comprising a filler (E).

[10] The thermosetting resin composition according to [9], wherein the filler (E) is at least one selected from the group consisting of silica, alumina, magnesium oxide, solid silicone rubber particles, and solid rubber particles.

[11] The thermosetting resin composition according [9] or [10], wherein the content of the filler (E) is 200 to 1900 parts by mass based on 100 parts by mass of the total of the polyalkenylphenol compound (A), the polymaleimide compound (B), the liquid polybutadiene compound (C), and the radical initiator (D).

[12] A cured product of the thermosetting resin composition according to any one of [1] to [11].

[13] A method for producing a structure, comprising molding the thermosetting resin composition according to any one of [1] to [11].

[14] A structure comprising the cured product according to [12].

### Advantageous Effects of Invention

According to the present disclosure, it is possible to obtain a thermosetting resin composition having low water absorption and excellent reflow resistance without impairing heat resistance and moldability. A highly reliable cured product can be formed using the thermosetting resin composition of the present disclosure.

### DESCRIPTION OF EMBODIMENTS

The present invention will be described in detail below. A thermosetting resin composition of one embodiment comprises a polyalkenylphenol compound (A), a polymaleimide compound (B), a liquid polybutadiene compound (C), and a radical initiator (D).

[Polyalkenylphenol Compound (a)]

The polyalkenylphenol compound (A) is a compound having at least 2 phenol skeletons in its molecule and having a 2-alkenyl group bonded to a part or all of aromatic rings forming a phenol skeleton in its molecule. As the 2-alkenyl group, those having a structure represented by the formula (3) are preferred.

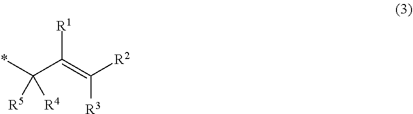

In the formula (3), R¹, R², R³, R⁴ and R⁵ are each independently a hydrogen atom, an alkyl group having 1 to 5 carbon atoms, a cycloalkyl group having 5 to 10 carbon atoms, or an aryl group having 6 to 12 carbon atoms. * of the formula (3) represents a bond portion with a carbon atom constituting an aromatic ring.

Specific examples of the alkyl group having 1 to 5 carbon atoms constituting R¹, R², R³, R⁴ and R⁵ in the formula (3) may include a methyl group, an ethyl group, an n-propyl group, an isopropyl group, an n-butyl group, a sec-butyl group, a tert-butyl group, and an n-pentyl group. Examples of the cycloalkyl group having 5 to 10 carbon atoms may include a cyclopentyl group, a cyclohexyl group, a methylcyclohexyl group, and a cycloheptyl group. Specific examples of the aryl group having 6 to 12 carbon atoms may include a phenyl group, a methylphenyl group, an ethylphenyl group, a biphenyl group, and a naphthyl group. It is preferable that the 2-alkenyl group represented by the formula (3) be an allyl group, i.e., all of R¹, R², R³, R⁴ and R⁵ are a hydrogen atom.

Examples of the basic skeleton of the polyalkenylphenol compound include a skeleton of a known phenol resin, such as a phenol novolak resin, a cresol novolak resin, a triphenylmethane type phenol resin, a phenol aralkyl resin, a biphenyl aralkyl phenol resin, and a phenol-dicyclopentadiene copolymer resin. In the polyalkenylphenol compound, a 2-alkenyl group is bonded to preferably 40 to 100%, more preferably 60 to 100%, and still more preferably 80 to 100% of aromatic rings of the total aromatic rings forming the phenol skeleton. Among them, a polyalkenylphenol compound having a structural unit represented by the following formula (2)-1 and optionally a structural unit represented by the formula (2)-2 can be preferably used.

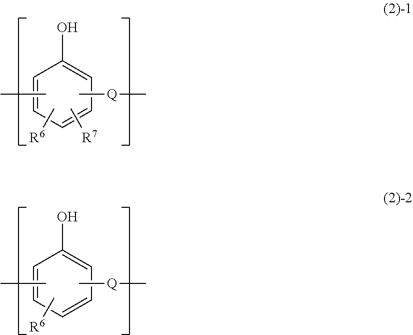

The structural units represented by the formula (2)-1 and the formula (2)-2 are the preferred phenol skeleton units constituting a polyalkenylphenol compound, and the bonding order of these phenol skeleton units is not particularly limited. In the formulas (2)-1 and (2)-2. R⁶ is each independently a hydrogen atom, an alkyl group having 1 to 5 carbon atoms, or an alkoxy group having 1 to S carbon atoms, and in the formula (2)-1, R⁷ is each independently a 2-alkenyl group represented by the formula (3). R⁶ and R⁷ may be the same or different in each of the phenol skeletal units. Q is each independently an alkylene group represented by a formula —CR⁸R⁹—, a cycloalkylene group having 5 to 10 carbon atoms, a divalent organic group having an aromatic ring, a divalent organic group having an alicyclic condensed ring, or a divalent organic group formed by combining these, and R⁹ and R⁹ are each independently a hydrogen atom, an alkyl group having 1 to 5 carbon atoms, an alkenyl group having 2 to 6 carbon atoms, a cycloalkyl group having 5 to 10 carbon atoms, or an aryl group having 6 to 12 carbon atoms.

When the average number per one molecule of the structural unit represented by the formula (2)-1 is p and the average number per one molecule of the structural unit represented by the formula (2)-2 is q, it is preferable that p be a real number from 1.1 to 35, p+q be a real number from 1.1 to 35, and q be a real number in which the value of the formula: p/(p+q) is from 0.4 to 1.

Specific examples of the alkyl group having 1 to 5 carbon atoms constituting R⁶ may include a methyl group, an ethyl group, an n-propyl group, an isopropyl group, an n-butyl group, a sec-butyl group, a tert-butyl group, and an n-pentyl group. Specific examples of the alkoxy group having 1 to 5 carbon atoms may include a methoxy group, an ethoxy group, an n-propoxy group, an isopropoxy group, an n-butoxy group, a sec-butoxy group, a tert-butoxy group, and an n-pentoxy group.

In R⁸ and R⁹ of the alkylene group represented by the formula —CR⁸R⁹—, specific examples of the alkyl group having 1 to 5 carbon atoms may include a methyl group, an ethyl group, an n-propyl group, an isopropyl group, an n-butyl group, a sec-butyl group, a tert-butyl group, and an n-pentyl group; specific examples of the alkenyl group having 2 to 6 carbon atoms may include a vinyl group, an allyl group, a butenyl group, a pentenyl group, and a hexenyl group; specific examples of the cycloalkyl group having 5 to 10 carbon atoms may include a cyclopentyl group, a cyclohexyl group, a methylcyclohexyl group, and a cycloheptyl group; specific examples of the aryl group having 6 to 12 carbon atoms may include a phenyl group, a methylphenyl group, an ethylphenyl group, a biphenyl group, and a naphthyl group.

Specific examples of the cycloalkylene group having 5 to 10 carbon atoms constituting Q may include a cyclopentylene group, a cyclohexylene group, a methylcyclohexylene group, and a cycloheptylene group. Specific examples of the divalent organic group having an aromatic ring may include a phenylene group, a tolylene group, a naphthylene group, a biphenylene group, a fluorenylene group, an anthranylene group, a xylylene group, and a 4,4-methylenediphenyl group. The number of carbon atoms of the divalent organic group having an aromatic ring may be 6 to 20 or 6 to 14. Specific examples of the divalent organic group having an alicyclic fused ring may include a dicyclopentadienylene group. The number of carbon atoms of the divalent organic group having an alicyclic fused ring may be 7 to 20 or 7 to 10.

It is preferable that Q be a dicyclopentadienylene group, a phenylene group, a methylphenylene group, a xylylene group, or a biphenylene group, in terms of the high mechanical strength of a cured product when used in a thermosetting resin composition. Since the polyalkenylphenol compound has a low viscosity and is favorable for mixing with the aromatic polymaleimide compound, Q is preferably —CH₂—.

p is preferably a real number from 1.1 to 35, more preferably a real number from 2 to 30, and even more preferably a real number from 3 to 10. When p is 1.1 or more, the thermal decomposition start temperature, when the cured product of the thermosetting resin composition is placed in a high temperature environment, is appropriate, and when p is 35 or less, the viscosity of the thermosetting resin composition is within a suitable range for the molding process.

p+q is preferably a real number from 1.1 to 35, more preferably a real number from 2 to 30, and even more preferably a real number from 3 to 10. When p+q is 1.1 or more, the thermal decomposition start temperature, when the cured product of the thermosetting resin composition is placed in a high temperature environment, is appropriate, and when p+q is 35 or less, the viscosity of the thermosetting resin composition is within a suitable range for the molding process.

q is preferably a real number in which the value of the formula p/(p+q) is from 0.4 to 1, more preferably a real number in which the value of the formula p/(p+q) is from 0.6 to 1, and even more preferably a real number in which the value of the formula p/(p+q) is from 0.8 to 1. When the value of the formula p/(p+q) is 1, q is 0. In this embodiment, the polyalkenylphenol compound does not contain the structural unit represented by the formula (2)-2. The polyalkenylphenol compound may consist of the structural unit represented by the formula (2)-1. When q is a value satisfying the above condition, the curability of the thermosetting resin composition can be made sufficient depending on the application.

The number average molecular weight Mn of the polyalkenylphenol compound is preferably from 300 to 5000, more preferably from 400 to 4000, and even more preferably from 500 to 3000. When the number average molecular weight Mn is 300 or more, the thermal decomposition start temperature, when the cured product of the thermosetting resin composition is placed in a high temperature environment, is appropriate, and when the number average molecular weight Mn is 5000 or less, the viscosity of the thermosetting resin composition is within a suitable range for the molding process.

### [Polymaleimide Compound (B)]

The polymaleimide compound (B) is a compound having 2 or more maleimide groups represented by the formula (4).

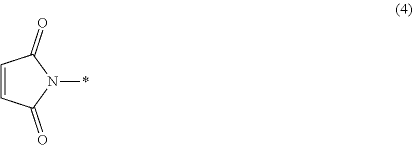 [SMILES: *N1C(=O)C=CC1=O]

In the formula (4), * represents a bond portion with an organic group containing an aromatic ring or a linear, branched or cyclic aliphatic hydrocarbon group.

Examples of the polymaleimide compound may include bismaleimides, such as bis(4-maleimidophenyl)methane, trismaleimides, such as tris(4-maleimidophenyl)methane, tetrakismaleimides, such as bis(3,4-dimaleimidophenyl)methane, and polymaleimides, such as poly(4-maleimidostyrene). Examples of the polymaleimide compound may include an aromatic polymaleimide compound and an aliphatic polymaleimide compound, and an aromatic polymaleimide compound is preferable from the viewpoint of the particularly excellent flame retardancy of the obtained cured product.

The aromatic polymaleimide compound is a compound having 2 or more maleimide groups represented by the formula (4), and these maleimide groups are bonded to the same or different aromatic rings. Specific examples of the aromatic ring may include a monocyclic ring, such as benzene, a fused ring, such as naphthalene and anthracene. From the viewpoint of mixing well in the curable resin composition, the polymaleimide compound is preferably an aromatic bismaleimide compound and an aliphatic bismaleimide compound, and more preferably an aromatic bismaleimide compound. Specific examples of the aromatic bismaleimide compound may include bis(4-maleimidophenyl)methane, bis(3-maleimidophenyl)methane, bis(3-methyl-4-maleimidophenyl)methane, bis(3,5-dimethyl-4-maleimidophenyl)methane, bis(3-ethyl-4-maleimidophenyl)methane, bis(3,5-diethyl-4-maleimidophenyl)methane, bis(3-propyl-4-maleimidophenyl)methane, bis(3,5-dipropyl-4-maleimidophenyl)methane, bis(3-butyl-4-maleimidophenyl)methane, bis(3,5-dibutyl-4-maleimidophenyl)methane, bis(3-ethyl-4-maleimido-5-methylphenyl)methane, 2,2-bis(4-maleimidophenyl)propane, 2,2-bis[4-(4-maleimidophenyloxy)phenyl]propane, bis(4-maleimidophenyl) ether, bis(3-maleimidophenyl) ether, bis(4-maleimidophenyl) ketone, bis(3-maleimidophenyl) ketone, bis(4-maleimidophenyl) sulfone, bis(3-maleimidophenyl) sulfone, bis[4-(4-maleimidophenyloxy)phenyl] sulfone, bis(4-maleimidophenyl) sulfide, bis(3-maleimidophenyl) sulfide, bis(4-maleimidophenyl) sulfoxide, bis(3-maleimidophenyl) sulfoxide, 1,4-bis(4-maleimidophenyl)cyclohexane, 1,4-dimaleimidonaphthalene, 2,3-dimaleimidonaphthalene, 1,5-dimaleimidonaphthalene, 1,8-dimaleimidonaphthalene, 2,6-dimaleimidonaphthalene, 2,7-dimaleimidonaphthalene, 4,4′-dimaleimidobiphenyl, 3,3′-dimaleimidobiphenyl, 3,4′-dimaleimidobiphenyl, 2,5-dimaleimido-1,3-xylene, 2,7-dimaleimidofluorene, 9,9-bis(4-maleimidophenyl)fluorene, 9,9-bis(4-maleimido-3-methylphenyl)fluorene, 9,9-bis(3-ethyl-4-maleimidophenyl)fluorene, 3,7-dimaleimido-2-methoxyfluorene, 9,10-dimaleimidophenanthrene, 1,2-dimaleimidoanthraquinone, 1,5-dimaleimidoanthraquinone, 2,6-dimaleimidoanthraquinone, 1,2-dimaleimidobenzene, 1,3-dimaleimidobenzene, 1,4-dimaleimidobenzene, 1,4-bis(4-maleimidophenyl)benzene, 2-methyl-1,4-dimaleimidobenzene, 2,3-dimethyl-1,4-dimaleimidobenzene, 2,5-dimethyl-1,4-dimaleimidobenzene, 2,6-dimethyl-1,4-dimaleimidobenzene, 4-ethyl-1,3-dimaleimidobenzene, 5-ethyl-1,3-dimaleimidobenzene, 4,0-dimethyl-1,3-dimaleimidobenzene, 2,4,6-trimethyl-1,3-dimaleimidobenzene, 2,3,5,6-tetramethyl-1,4-dimaleimidobenzene, and 4-methyl-1,3-dimaleimidobenzene. Specific examples of the aliphatic bismaleimide compound may include bis(4-maleimidocyclohexyl)methane and bis(3-maleimidocyclohexyl)methane. Among them, bis(4-maleimidophenyl)methane and 2,2-bis[4-(4-maleimidophenyloxy)phenyl]propane are preferred. Examples of commercial products include, for example, the BMI (trade name, manufactured by Daiwa Chemical Co., Ltd.) series.

With respect to 100 parts by mass of the polymaleimide compound (B), the blending amount of the polyalkenylphenol compound (A) is preferably 5 to 200 parts by mass, more preferably 10 to 150 parts by mass, and still more preferably 20 to 130 parts by mass. When the above blending amount is 5 parts by mass or more, the fluidity at the time of molding is more satisfactory. On the other hand, when the above blending amount is 200 parts by mass or less, the heat resistance of the cured product is more satisfactory.

### [Liquid Polybutadiene Compound (C)]

The liquid polybutadiene compound (C) includes a structural unit represented by the formula (1)-1, and when the liquid polybutadiene compound contains only a structural unit represented by the formula (1)-1, 2 or more structural units represented by the formula (1)-1 are contained in one molecule.

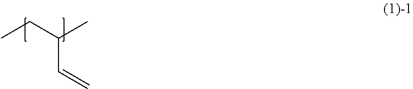

In this disclosure, “liquid” means that the polybutadiene compound has fluidity at 40° C. For example, the viscosity of the liquid polybutadiene compound is preferably 2 to 100 Pa-s, more preferably 5 to 40 Pa-s, and still more preferably 5 to 30 Pa-s, when measurement is carried out using a Brookfield type viscometer under conditions with a temperature of 40° C., a spindle RV-1, and a rotation speed of 10 min⁻¹.

The liquid polybutadiene compound may further include a structural unit represented by the formula (1)-2. In this embodiment, a total of 2 or more structural units represented by the formula (1)-1 and the formula (1)-2 are contained in one molecule.

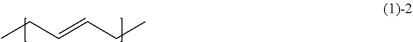

The liquid polybutadiene compound may further include a structural unit other than the structural units represented by the formula (1)-1 and the formula (1)-2. The structural unit other than the structural units represented by the formula (1)-1 and the formula (l)-2 may be derived from a monomer copolymerizable with butadiene. Examples of the monomer copolymerizable with butadiene may include styrene, maleic acid and maleic anhydride, acrylic acid, methacrylic acid, norbornene, dicyclopentadiene, N-vinyl-2-pyrrolidone, acrylonitrile, and an unsaturated aliphatic compound, such as butene, and propene. The molecular weight of the monomer copolymerizable with butadiene is preferably from 40 to 600, more preferably from 60 to 200, and even more preferably from 80 to 150.

Examples of the structural unit other than the structural units represented by the formula (1)-1 and the formula (1)-2 may include the structural units of the formula (1)-3, the formula (1)-4 and the formula (1)-5. By including the structural unit of the formula (1)-3, the compatibility with other resins can be controlled. By including the structural unit of the formula (1)-4 or the formula (1)-5, it is possible to control the curing rate or the adhesion to a different material when the thermosetting resin composition is cured.

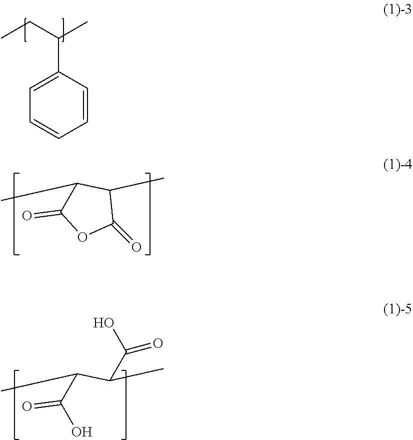

In one embodiment, when the average number per one molecule of the structural unit represented by the formula (1)-1 is m, the average number per one molecule of the structural unit represented by the formula (1)-2 is n, and the average number per one molecule of the structural unit other than the structural units represented by the formula (1)-1 and the formula (1)-2 is w, m/(m+n+w) is from 0.15 to 1. m/(m+n+w) is preferably from 0.5 to 1, more preferably from 0.8 to 1. When m/(m+n+w) is 0.15 or more, the reactivity of the liquid polybutadiene compound with the polyalkenylphenol compound (A) or the polymaleimide compound (B) is satisfactory, and thus the liquid polybutadiene compound can be incorporated into the cured product. This can suppress bleed-out of the liquid polybutadiene compound onto the surface of the cured product after molding.

w/(m+n+w) is preferably from 0 to 0.5, more preferably from 0 to 0.35, and even more preferably from 0 to 0.2.

In one embodiment, the liquid polybutadiene compound comprises at least one selected from polybutadiene, a butadiene-styrene copolymer, and maleic acid-modified polybutadiene. The maleic acid-modified polybutadiene comprises an acid anhydride group, a carboxy group, or both of them. The carboxy group may be in the form of a salt or an ester.

Examples of the terminal group bonded to the above structural unit of the liquid polybutadiene compound may include a hydrogen atom, an alkyl group having 1 to 4 carbon atoms, such as a methyl group, an ethyl group, an n-propyl group, an isopropyl group, an n-butyl group, an isobutyl group, a sec-butyl group, and a tert-butyl group, a hydroxy group, a carboxy group, and an amino group. From the viewpoint of the water absorption, the terminal group is preferably a hydrogen atom or an alkyl group having 1 to 4 carbon atoms.

The content of the liquid polybutadiene compound can be appropriately determined depending on the application. The content of the liquid polybutadiene compound can be determined so that the ratio of [liquid polybutadiene compound (C)/polyalkenylphenol compound (A)+polymaleimide compound (B)+liquid polybutadiene compound (C)] is preferably from 5 to 40% by mass, more preferably from 10 to 20% by mass. When the ratio of the liquid polybutadiene compound is 5% by mass or more, the water absorption rate of the thermosetting resin composition can be reduced, and the reflow resistance can be improved. When the ratio of the liquid polybutadiene compound is 40% by mass or less, the melting point or the softening point of the thermosetting resin composition before molding can be appropriately adjusted to improve the handling property, and the bleed-out of the liquid polybutadiene compound after curing can be suppressed.

The molecular weight of the liquid polybutadiene compound can be appropriately determined depending on the application. The number average molecular weight Mn of the liquid polybutadiene compound is preferably from 2000 to 50000, more preferably from 2000 to 35000, and still more preferably from 2000 to 27000. When the number average molecular weight Mn of the liquid polybutadiene compound is 2000 or more, it is easy to keep the melting point or the softening point of the thermosetting resin composition before molding at room temperature or higher, and the handling property of the thermosetting resin composition can be improved. Further, when the number average molecular weight Mn of the liquid polybutadiene compound is 2000 or more, the diffusion separation rate of the liquid polybutadiene compound with respect to the polyalkenylphenol compound (A) or the polymaleimide compound (B) during molding and curing of the thermosetting resin composition can be slowed down to such an extent that the bleed-out of the liquid polybutadiene compound to the surface of the cured product is suppressed, thereby improving the appearance of the molded product or the moldability of the thermosetting resin composition. When the number average molecular weight Mn of the liquid polybutadiene compound is 50000 or less, the thermosetting resin composition can be filled inside the mold within the molding and curing time, since the viscosity of the thermosetting resin composition at the time of molding is set in an appropriate range.

### [Radical Initiator (D)]

By blending the radical initiator (D) in the thermosetting resin composition, curing of the thermosetting resin composition can be accelerated. Examples of the radical initiator may include a photoradical initiator and a thermal radical initiator. The radical initiator is preferably a thermal radical initiator. Examples of the thermal radical initiator may include an organic peroxide. The organic peroxide is preferably an organic peroxide having a half-life temperature of 10 hours of 100 to 170° C., and specific examples thereof may include dicumyl peroxide, 2,5-dimethyl-2,5-di(tert-butylperoxy)hexane, tert-butyl cumyl peroxide, di-butyl peroxide, 1,1,3,3-tetramethylbutyl hydroperoxide, and cumene hydroperoxide. The preferred amount used of the radical initiator is from 0.01 to 10 parts by mass, more preferably from 0.05 to 7.5 parts by mass, and still more preferably from 0.1 to 5 parts by mass, based on 100 parts by mass of the total of the polyalkenylphenol compound (A), the polymaleimide compound (B), and the liquid polybutadiene compound (C). When the amount used of the radical initiator is 0.01 parts by mass or more, a curing reaction proceeds sufficiently, and when the amount is 10 parts by mass or less, the storage stability of the thermosetting resin composition is more satisfactory.

### [Filler (E)]

The thermosetting resin composition may further comprise a filler (E). There is no particular limitation on the type of the filler, and examples thereof may include an organic filler, such as solid silicone rubber particles, solid rubber particles, and a silicone powder, and an inorganic filler, such as silica, alumina, magnesium oxide, and boron nitride, and can be appropriately selected depending on the application. In one embodiment, the filler is at least one selected from the group consisting of silica, alumina, magnesium oxide, solid silicone rubber particles, and solid rubber particles.

For example, when the thermosetting resin composition is used in a semiconductor encapsulating application, it is preferable to incorporate an inorganic filler which is insulating in order to obtain a cured product having a low thermal expansion coefficient. The inorganic filler is not particularly limited, and known one can be used. Specific examples of the inorganic filler may include particles including silica, such as amorphous silica and crystalline silica, alumina, boron nitride, aluminum nitride, and silicon nitride. True spherical amorphous silica is desirable from the viewpoint of the low viscosity. The inorganic filler may be one subjected to surface treatment with a silane coupling agent or the like, or it may not be subjected to surface treatment.

The average particle diameter of the filler is preferably from 0.1 to 30 μm, more preferably those having a maximum particle diameter of 100 μm or less, and particularly 75 μm or less. When the average particle diameter is in this range, the viscosity of the thermosetting resin composition is suitable in use, and the injectability into a narrow pitch wiring portion or a narrow gap portion is also suitable. The average particle diameter referred to herein is a volume cumulative particle diameter D₅₀ measured by a laser diffraction/scattering particle size distribution analyzer.

The content of the filler in the thermosetting resin composition can be appropriately determined depending on the application. The content of the filler in the thermosetting resin composition is preferably from 200 to 1900 parts by mass, more preferably from 300 to M) parts by mass, and still more preferably from 300 to 600 parts by mass, based on 100 parts by mass of the total of the polyalkenylphenol compound (A), the polymaleimide compound (B), the liquid polybutadiene compound (C), and the radical initiator (D).

As other additives, a coupling agent, an antifoaming agent, a coloring agent, a phosphor, a modifying agent, a leveling agent, a light diffusing agent, a flame retardant, an adhesive imparting agent, a mold releasing agent, or the like can be blended in the thermosetting resin composition. For example, a coupling agent may be blended from the viewpoint of improving adhesion. The coupling agent is not particularly limited, and examples thereof may include a silane coupling agent, such as vinyltriethoxysilane, vinyltrimethoxysilane, 3-glycidoxypropyltrimethoxysilane, γ-methacryloxypropyltrimethoxysilane, γ-aminopropyltrimethoxysilane, and N-phenyl-3-aminopropyltrimethoxysilane. A single coupling agent may be used, or 2 or more of them may be used in combination. The amount blended of the coupling agent in the thermosetting resin composition is preferably from 0.1 to 5% by mass. When the above blending amount is 0.1% by mass or more, the effect of the coupling agent is sufficiently exhibited, and when the blending amount is 5% by mass or less, the melt viscosity, the hygroscopicity and strength of the cured product are more satisfactory.

### [Method of Preparing a Thermosetting Resin Composition]

The method of preparing a thermosetting resin composition is not particularly limited as long as the polyalkenylphenol compound (A), the polymaleimide compound (B), the liquid polybutadiene compound (C), the radical initiator (D), and other optional components can be uniformly mixed and dispersed. The method in which the polyalkenylphenol compound (A), the polymaleimide compound (B), and the liquid polybutadiene compound (C) are previously melt-mixed and then the radical initiator (D) and an optional additive are added is preferred, since each component can be uniformly mixed.

The method of mixing each component is not particularly limited. Each component in a predetermined blending ratio can be mixed with other components by feeding them into a mixer, such as a reaction vessel, a pot mill, a two-roll mill, a three-roll mill, a rotary mixer, a twin-axis mixer, a disper mixer, a single-axis or twin-axis (coaxial or different direction) extruder, and a kneader, and stirring or kneading them. On a laboratory scale, a rotary mixer is preferable, since the stirring conditions can be easily changed, and a two-axis mixer is preferable in industry from the viewpoint of the productivity. Each mixer can be used by appropriately changing the stirring conditions.

When powdering the thermosetting resin composition is carried out, there is no particular limitation as long as it is a method in which the resin is not melted by heat generated during an operation step. It may be convenient to use an agate mortar when the thermosetting resin composition is in a small amount. When a commercially available pulverizer is utilized, those having a small amount of heat generated during pulverization are preferable for suppressing melting of the mixture. The particle size of the powder is preferably 1 mm or less.

### [Method of Producing a Structure]

The thermosetting resin composition can be melted by heating. A structure can be produced by molding the molten thermosetting resin composition into a desired shape, curing it if necessary, and demolding it. As a method of producing the structure, molding, in particular, transfer molding and compression molding are preferable. As preferable conditions for transfer molding, for example, in the case of a mold having a size of 10 mm×75 mm×3 mm, the temperature of the top plate and the mold is from 170 to 190° C. the holding pressure is from 50 to 150 kg/cm², and the holding time is from 1.5 to 10 minutes. As preferable conditions for compression molding, for example, in the case of a mold having a size of 100 mm×75 mm×3 mm, the temperature of the top plate and the mold is 170 to 190° C., the molding pressure is from 5 to 20 MPa. and the pressurizing time is from 1.5 to 10 minutes.

### [Method of Producing a Cured Product]

The thermosetting resin composition can be cured by heating. The curing temperature is preferably from 130 to 300° C., more preferably from 150 to 230° C., and still more preferably from ISO to 200° C. When the curing temperature is 130° C. or higher, the thermosetting resin composition before curing can be sufficiently melted and easily filled into a mold, and the mold after curing can be easily demolded. If the curing temperature is 300° C. or less, the thermal degradation or volatilization of the material can be avoided. The heating time can be appropriately changed according to the thermosetting resin composition and the curing temperature, and is preferably from 0.1 to 24 hours from the viewpoint of the productivity. The heating may be carried out in a plurality of times. In particular, when a high degree of curing is desired, it is preferable that the temperature be increased with the progress of curing, for example, so that a final curing temperature is 250° C. or less, and more preferably 230° C. or less, without curing at an excessively high temperature.

### [Use of a Cured Product]

A cured product of the thermosetting resin composition can be used for, for example, a semiconductor encapsulating material, a prepreg, an interlayer insulating resin, a solder resist, and a die attach.

### EXAMPLES

Hereinafter, the invention will be specifically described based on examples and comparative examples, but the invention is not limited to the examples.

The analysis methods and the characteristic evaluation methods used in the examples and comparative examples are as follows.

### [Analysis Methods and Characteristic Evaluation Method]

### [Molecular Weight]

The measuring conditions for GPC apparatus were as follows.

Apparatus: JASCO LC-2000 plus (manufactured by JASCO Corporation)

Column: Shodex (registered trademark) LF-804 (manufactured by Showa Denko K.K.)

Mobile phase: Tetrahydrofuran

Flow rate: 1.0 mL/min

Detector: JASCO RI-2031 plus (manufactured by JASCO Corporation)

Temperature: 40° C.

In the above measuring conditions, the number average molecular weight Mn and the weight average molecular weight Mw were calculated based on a calibration curve prepared by using a polystyrene standard substance.

### [Degree of Polymerization]

The degree of polymerization P was determined by the following formula, where Mn was the number average molecular weight calculated from GPC and M was the molecular weight of the repeating structure of the polyalkenylphenol compound.

P=Mn/M

### [Glass Transition Temperature (Tg)]

The thermosetting resin composition was molded using a transfer molding machine under conditions with a mold temperature of 180° C., a holding pressure of 100 kg/cm², and a holding time of 3 minutes, to prepare a test piece of 5 mm×5 mm×5 mm for measuring a glass transition temperature. The test piece was heated at 200° C. for 5 hours, cured, and then measured by thermomechanical measurement (TMA). Measurement of the test piece was carried out using a TMA/SS6100 thermomechanical analyzer manufactured by SII Nanotechnology Inc., under conditions with a temperature range of 30 to 300° C., a temperature rise rate of 5° C./min, and a load of 20.0 mN. The temperature of the displacement point of the linear expansion coefficient was defined as Tg.

### [Pyrolysis Temperature (Td)]

Test pieces were prepared by molding the thermosetting resin compositions using a transfer molding machine under conditions with a mold temperature of 180° C., a holding pressure of 100 kg/cm², and a holding time of 3 minutes. The obtained test pieces were post-cured at a temperature of 200° C. for 5 hours. The resulting cured products were pulverized using a diamond file, and then heated using a TG-DTA/SS6000 thermogravimetric differential thermal analyzer manufactured by SIT Nanotechnology Inc., to obtain weight loss curves at a temperature from 50 to 450° C. and a heating rate of 10° C./min. In the obtained weight loss curves, the temperature obtained in accordance with the starting temperature TI at the time of one-stage weight reduction described in JIS K 7120:1987 was defined as the pyrolysis temperature Td.

### [Flexural Strength and Flexural Modulus]

A test piece of 100 mm×10 mm×4 mm was prepared by molding the thermosetting resin compositions using a transfer molding machine under conditions with a mold temperature of 180° C. a holding pressure of 100 kg/cm², and a holding time of 3 minutes. Post-curing at 200° C. for 5 hours was carried out, and then in accordance with JIS K 7171:2016, in a constant temperature room kept at room temperature, 23° C., a three-point bending test was carried out using a universal testing machine (Strograph, manufactured by Toyo Seiki Seisaku-sho, Ltd.). The flexural strength when moved at a displacement rate of 2 mm was defined as the flexural strength, and the initial inclination of the displacement-stress was defined as the flexural modulus.

### [Water Absorption Rate]

A test piece of 50 mm×50 mm×3 mm was prepared by a transfer molding machine under the same conditions as the bending test piece described above, and post-cured at 200° C. for 5 hours. By using a precision balance, the mass of the test piece dried for 24 hours at 50° C. immediately before the test was measured as W1 and the mass of the test piece after standing for 24 hours under 121° C. saturated water vapor conditions was measured as W2. The value obtained by (W2−W1)/W1 was calculated as the water absorption rate.

### [Poor Appearance (Bleed-Out)]

The thermosetting resin composition was molded by using a transfer molding machine under conditions with a mold temperature of 180° C. a holding pressure of 100 kg/cm², and a holding time of 3 minutes. The mold and the molded product after the molded product obtained were taken out were visually observed. A case in which there is no haze in the mold and no resin which has been exuded without curing was observed on the surface of the molded article was evaluated as good, and the other was evaluated as defective.

### [Reflow Resistance]

A lead frame made of rolled oxygen-free copper (C1020), having an outer dimension of 52 mm in width, 38 mm in length, and 0.5 mm in thickness, and having a bed in the center in length and width of 18 mm was used. The center of the lead frame was aligned, and the bed was encapsulated by the thermosetting resin composition in an outer dimension of 30 mm in length, 30 mm in width, and 3 mm in thickness. The thermosetting resin composition was molded using a transfer molding machine under conditions with a mold temperature of 180° C., a holding pressure of 100 kg/cm², and a holding time of 3 minutes, and the resulting test piece was post-cured at 200° C. for 5 hours. Then, a reflow test was carried out using a reflow simulator SRS-1 manufactured by Marcom Co., Ltd., in accordance with the condition of Level 3 of IPC/JEDEC J-STD-020D.

Test pieces before and after the reflow resistance test were observed for the state of peeling of the interface between the lead frame made of oxygen-free copper and the cured product of the thermosetting resin composition using an ultrasonic flaw detection imaging device (HA-60A, manufactured by Honda Electronics Co., Ltd.). Five samples (N=5) without peeling were prepared before the reflow resistance test, and after the test, the case where four or more samples (N=4 or more) without peeling remained was evaluated as excellent, the case where two or more samples (N=2 or more) without peeling remained was evaluated as good, and others were evaluated as defective.

### [Starting Materials]

[Polyallylphenol Compound (a)]
BRG-APO (R⁶ in the formula (2)-1=a hydrogen atom, Q═—CR⁸R⁹—, R⁸ and R⁹=hydrogen atoms, and R¹ to R⁵ in the formula (3)=hydrogen atoms)

A resin in which an ortho or a para position of a phenolic hydroxy group was allylated (hydroxy group equivalent of 154, number average molecular weight Mn of 1000, weight average molecular weight Mw of 3000, degree of polymerization of 6.6, p=6.6, q=0) was produced by using a 1:1 mixture of phenolic novolak resins SHONOL (registered trademark) BRG-556 and BRG-558 (manufactured by Aica Kogyo Co., Ltd.). Example 3 of JP2016-28129A can be referred to for a manufacturing method.
HE100C-APO (R⁶s of the formula (2)-1 and the formula (2)-2=hydrogen atoms, R¹ to R⁵ of the formula (3)=hydrogen atoms, Q=a p-xylylene group)

A resin in which an ortho or a para position of a phenolic hydroxy group was allylated (hydroxy group equivalent of 222, number average molecular weight Mn of 900, weight average molecular weight Mw of 1900, degree of polymerization of 4.0, p=3.8, q=0.2) was produced by using a phenol aralkyl resin HE100C-10-15 (manufactured by Air Water Inc.). Example 1 of JP2016-28129A can be referred to for a manufacturing method.

### [Aromatic Bismaleimide Compound (B)]

BMI-4000 (2,2-bis[4-(4-maleimidophenyloxy)phenyl]propane, manufactured by Daiwa Kasei Industry Co., Ltd.)
BMI-100H (bis(4-maleimidophenyl)methane, manufactured by Daiwa Kasei Industry Co., Ltd.)

### [Liquid Polybutadiene Compound (C)]

KURAPRENE (registered trademark) LBR305 (number average molecular weight Mn of 26000, m/(m+n+w)=0.2 (w:=0), manufactured by Kuraray Co., Ltd)
B3000 (number average molecular weight Mn of 3200,m/(m+n+w)=1 (w:=0), manufactured by Nippon Soda Co., Ltd.)
KURAPRENE (registered trademark) LBR352 (number average molecular weight Mn of 9700, m/(m+n+w)=0.7 (w=0), manufactured by Kuraray Co., Ltd.)
Ricon (trademark) 100 (number average molecular weight Mn of 4500, m/((m+n+w)=0.53, w/((m+n+w)=0.25 (styrene ratio of 25%), manufactured by Cray Valley)
Ricon (trademark) 131MA5 (number average molecular weight Mn of 4700, m/(m+n+w)=0.26, maleic acid modification ratio of 2 (maleic acid groups/molecular chains), w/((m+n+w)=0.02, manufactured by Cray Valley)

### [Radical Initiator (D)]

Percumyl (registered trademark) D (dicumyl peroxide, manufactured by NOF Corp.)

### [Filler (E)]

Silica filler MSR2212 (spherical silica, average particle diameter of 22.7 μm, manufactured by Tatsumori, Ltd.) was treated using 0.5% by mass of a silane coupling agent KBM-603 (manufactured by Shin-Etsu Chemical Co., Ltd.).

The following polyisoprene, epoxy resin, phenol resin, and liquid polybutadiene compound were used as other resins.
KURAPRENE (registered trademark) KL-10 (number average molecular weight Mn of 10000, 1,2-isoprene ratio of 20%, manufactured by Kuraray Co., Ltd.)
KURAPRENE (registered trademark) LIR-30 (number-average molecular weight Mn of 28000, 1,2-isoprene ratio of 20%, manufactured by Kuraray Co., Ltd.)
Cresol novolak-type epoxy resin EPICLON (registered trademark)N-680 (manufactured by DIC Corp.)
Phenolic resin SHONOL (registered trademark) BRG-558 (manufactured by Aica Kogyo Co., Ltd.).
Polyoil 110 (number average molecular weight Mn of 1600, m/(m+n+w)=0.01 (w=0), manufactured by Zeon Corp.)

### Production of Thermosetting Resin Composition

### Example 1

30 parts by mass of BRG-APO, 55 parts by mass of BMI-4000, 15 parts by mass of LBR305, 1.5 parts by mass of percumyl D as a radical initiator, and 400 parts by mass of MSR2212 obtained by coupling agent treatment with KBM-603 as a filler were mixed and melt-kneaded (using two rolls (roll diameter 8 inches) manufactured by Toyo Seiki Seisaku-sho, Ltd., at 110° C., 10 minutes). After cooling and solidifying for 1 hours at room temperature (25° C.), the mixture was pulverized using a mill mixer (manufactured by Osaka Chemical Co., Ltd., Model WB-1, 25° C., 30 seconds) to obtain a powdery thermosetting resin composition. The obtained thermosetting resin composition was pressed into a tablet shape by a tablet press (manufactured by Fuji Machinery Co., Ltd.) and molded by a transfer molding machine to produce each of the test pieces described above and evaluate.

### Examples 2 to 8 and Comparative Examples 1 to 4

Production of thermosetting resin compositions and evaluation thereof were carried out in the same manner as in Example 1, except that the type and the amount of the component were changed as in Table 1.

[Table 1-1]

TABLE 1

| | | | | | | | |
|---|---|---|---|---|---|---|---|
| EXAMPLE 1 | EXAMPLE 2 | EXAMPLE 3 | EXAMPLE 4 | EXAMPLE 5 | EXAMPLE 6 | EXAMPLE 7 | EXAMPLE 8 |

Composition [Mass part]

| | | | | | | | | | |
|---|---|---|---|---|---|---|---|---|---|
| Polysilkenylphenol | BRG-APO | 30 | 27 | — | 30 | 30 | 30 | 30 | 30 |
| compound ( [symbol] ) | HE100C-APO | — | — | 30 | — | — | — | — | — |
| Polymalemide compound | BMI-4000 | 55 | 48 | 55 | — | 55 | 55 | 55 | 55 |
| (B) | BMI-1100H | — | — | — | 55 | — | — | — | — |
| Liquid [symbol] | LBR.30.5:0.2 | 15 | 15 | 15 | 15 | — | — | — | — |
| compound (C) | B3000:1 | — | — | — | — | 15 | — | — | 14 |
| [symbol] m [symbol] (m + n + w) | Ricom™ 100:0.53 | — | — | — | — | — | — | 15 | — |
| | Ricon ™ [symbol] MA | — | — | — | — | — | — | — | 1 |
| | 5.0:26 | | | | | | | | |
| Other resin components | N-680 | — | 10 | — | — | — | — | — | — |
| | BRG-558 | — | — | — | — | — | — | — | — |
| | KL-10 | — | — | — | — | — | — | — | — |
| | LIR-30 | — | — | — | — | — | — | — | — |
| Polyol 110 | — | — | — | — | — | — | — | — | |
| Radical imitiator (D) | [symbol] (registered | 1.5 | 1.5 | 1.5 | 1.5 | 1.5 | 1.5 | 1.5 | 1.5 |
| | trademark) D | | | | | | | | |
| Filler (E) | MSB2212 | 400 | 400 | 400 | 400 | 400 | 400 | 400 | 400 |

| | | | | | | | | |
|---|---|---|---|---|---|---|---|---|
| Evaluation results | | | | | | | | |
| Glass transition temperature Tg [° C.] | 255 | 245 | 258 | 290 | 248 | 251 | 255 | 233 |
| [symbol] temperature Td (° C.) | 428 | 419 | 425 | 421 | 428 | 420 | 419 | 428 |
| Flexural modulus [GPa] | 14 | 13 | 14 | 13 | 17 | 15 | 13 | 16 |
| Water absorption rate [mass %] | 0.35 | 0.39 | 0.35 | 0.35 | 0.35 | 0.35 | 0.35 | 0.38 |
| Bleed-out | Good | Good | Good | Good | Good | Good | Good | Good |
| Raflow resistance | Good | Good | Excellent | Good | Good | Good | Excellent | Exccellent |

| | | Comparative Example 1 | Comparative Example 2 | Comparative Example 3 | Comparative Example 4 |
|---|---|---|---|---|---|
| Composition [Mass part] | | | | | |
| Polysilkenylphenol | BRG-APO | — | 30 | 30 | 30 |
| compound ( [symbol] ) | HE100C-APO | — | — | — | — |
| Polymalemide compound | BMI-4000 | — | 55 | 55 | 55 |
| (B) | BMI-1100H | — | — | — | — |
| Liquid [symbol] | LBR.30.5:0.2 | 15 | — | — | — |
| compound (C) | B3000:1 | — | — | — | — |
| [symbol] m [symbol] (m + n + w) | Ricom ™ 100:0.53 | — | — | — | — |
| | Ricon ™ [symbol] MA | — | — | — | — |
| | 5.0:26 | | | | |
| Other resin components | N-680 | — | — | — | — |
| | BRG-558 | — | — | — | — |
| | KL-10 | — | 15 | — | — |
| | LIR-30 | — | — | 15 | — |
| Polyol 110 | — | — | — | 15 | |
| Radical imitiator (D) | [symbol] (registered | 1.5 | 1.5 | 1.5 | 1.5 |
| | trademark) D | | | | |
| Filler (E) | MSB2212 | 400 | 400 | 400 | 400 |

Evaluation results

| Glass transition temperature Tg [° C.] | Not measurable | Not measurable | Not measurable | Not measurable |
|---|---|---|---|---|
| [symbol] temperature Td (° C.) | Not measurable | 346 | 338 | Not measurable |
| | | 420 | 420 | |

| | | | | |
|---|---|---|---|---|
| Flexural modulus [GPa] | Not measurable | 15 | 15 | Not measurable |
| Water absorption rate [mass %] | Not measurable | 0.43 | 0.39 | Not measurable |
| Bleed-out | Defective | Defective | Good | Defective |
| Raflow resistance | Not measurable | Defective | Defective | Not measurable |

[symbol]

indicates data missing or illegible when filed

In Examples 1 to 8, the pyrolysis temperature, the flexural modulus, and the water absorption rate were all good, and the bleed-out and the reflow resistance were also good. On the other hand, in Comparative Examples 1 and 4, sticking to the mold or the like and the stickiness of the molded article at the time of transfer molding were severe, so that the molding could not be carried out. In Comparative Examples 2 and 3, two inflection points were observed when the pyrolysis temperature was measured. The first inflection points were 346° C. and 338° C., respectively, which were considerably lower than those of the Examples, and the liquid rubber component was not reacted and cured with BMI-4000 and BRG-APO which were other resin components, and it was observed that the heat resistance of the entire material decreased.

1. A thermosetting resin composition comprising a polyalkenylphenol compound (A), a polymaleimide compound (B), a liquid polybutadiene compound (C), and a radical initiator (D), wherein the liquid polybutadiene compound (C) has a structural unit represented by the formula (1)-1: 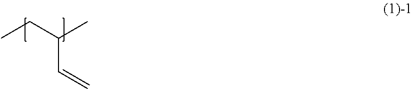
and optionally a structural unit represented by the formula (1)-2: 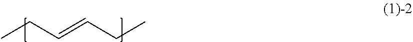
and optionally a structural unit other than the structural units represented by the formula (1)-1 and the formula (1)-2, wherein the ratio of m/(m+n+w) is 0.15 to 1, when the average number per one molecule of the structural unit represented by the formula (1)-1 is defined as m, the average number per one molecule of the structural unit represented by the formula (1)-2 is defined as n, and the average number per one molecule of the structural unit other than the structural units represented by the formula (1)-1 and the formula (1)-2 is defined as w.

2. The thermosetting resin composition according to claim 1, wherein the content of the liquid polybutadiene compound (C) is 5 to 40% by mass based on the total of the polyalkenylphenol compound (A), the polymaleimide compound (B), and the liquid polybutadiene compound (C).

3. The thermosetting resin composition according to claim 1, wherein the number average molecular weight Mn of the liquid polybutadiene compound (C) is 2000 to 50000.

4. The thermosetting resin composition according to claim 1, wherein the liquid polybutadiene compound (C) contains at least one selected from polybutadiene, a butadiene-styrene copolymer, and maleic acid-modified polybutadiene.

5. The thermosetting resin composition according to claim 1, wherein the polyalkenylphenol compound (A) is a polyalkenylphenol compound having a structural unit represented by the formula (2)-1: 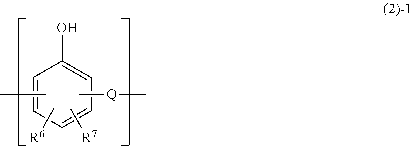
and optionally a structural unit represented by the formula (2)-2: 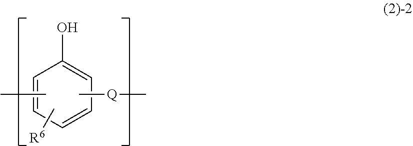
wherein, in the formula (2)-1 and the formula (2)-2, R⁶ is each independently a hydrogen atom, an alkyl group having 1 to 5 carbon atoms, or an alkoxy group having 1 to 5 carbon atoms, and R⁷ is each independently an alkenyl group represented by the formula (3): 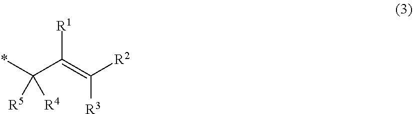
wherein, in the formula (3), R¹, R², R³, R⁴ and R⁵ are each independently a hydrogen atom, an alkyl group having 1 to 5 carbon atoms, a cycloalkyl group having 5 to 10 carbon atoms, or an aryl group having 6 to 12 carbon atoms, and * of the formula (3) is a bond portion with a carbon atom constituting an aromatic ring, and R⁶ and R⁷ may be the same or different in each of the phenol skeletal units, and Q is independently an alkylene group represented by the formula —CR⁸R⁹—, a cycloalkylene group having 5 to 10 carbon atoms, a divalent organic group having an aromatic ring, a divalent organic group having an alicyclic fused ring, or a divalent organic group formed by combining these, and R⁸ and R⁹ are each independently a hydrogen atom, an alkyl group having 1 to 5 carbon atoms, an alkenyl group having 2 to 6 carbon atoms, a cycloalkyl group having 5 to 10 carbon atoms, or an aryl group having 6 to 12 carbon atoms.

6. The thermosetting resin composition according to claim 5, wherein p is a real number of 1.1 to 35, p+q is a real number of 1.1 to 35, and q is a real number in which the value of the formula: p/(p+q) is 0.4 to 1, where p is the average number per one molecule of the structural unit represented by the formula (2)-1 and q is the average number per one molecule of the structural unit represented by the formula (2)-2.

7. The thermosetting resin composition according to claim 1, wherein the polymaleimide compound (B) is an aromatic bismaleimide compound.

8. The thermosetting resin composition according to claim 1, wherein the radical initiator (D) is an organic peroxide.

9. The thermosetting resin composition according to claim 1, further comprising a filler (E).

10. The thermosetting resin composition according to claim 9, wherein the filler (E) is at least one selected from the group consisting of silica, alumina, magnesium oxide, solid silicone rubber particles, and solid rubber particles.

11. The thermosetting resin composition according to claim 9, wherein the content of the filler (E) is 200 to 1900 parts by mass based on 100 parts by mass of the total of the polyalkenylphenol compound (A), the polymaleimide compound (B), the liquid polybutadiene compound (C), and the radical initiator (D).

12. A cured product of the thermosetting resin composition according to claim 1.

13. A method for producing a structure, comprising molding the thermosetting resin composition according to claim 1.

14. A structure comprising the cured product according to claim 12.

15. The thermosetting resin composition according to claim 2, wherein the number average molecular weight Mn of the liquid polybutadiene compound (C) is 2000 to 50000.
